(19) United States
(12) Patent Application Publication
(10) Pub. No.: US 2019/0122297 A1
(43) Pub. Date: Apr. 25, 2019

(54) Method for Hybrid currency and Volatility risk hedged currency

(71) Applicant: Arisa Goto, (US)

(72) Inventor: Arisa Goto, Redondo Beach, CA (US)

(73) Assignee: Arisa Goto, Redondo Beach, CA (US)

(21) Appl. No.: 16/166,045

(22) Filed: Oct. 19, 2018

Related U.S. Application Data
(60) Provisional application No. 62/575,055, filed on Oct. 20, 2017.

(51) Int. Cl. G06Q 40/04; G06Q 40/06

(52) U.S. Cl. CPC G06Q 40/04; G06Q 40/06

(57) ABSTRACT

A method and structure for allowing creations of hybrid currency and/or volatility risk hedged currency are provided. For certain embodiments, a hybrid currency and/or volatility risk hedged currency allow an individual to own a set of different currencies by simply holding currencies in the individual hybrid currency and/or volatility risk hedged currency. For some embodiments, hybrid currency and/or volatility risk hedged currency provide a unit of value that is an average, including but not limited to equal-weighted average of component currencies of hybrid currency and/or volatility risk hedged currency.

### TECHNICAL FIELD

This invention relates generally to digital currencies, cryptocurrencies, financial services and products, and more particularly to a structure of stable coins, asset-pegged digital currencies and asset-backed digital currencies.

### BACKGROUND

Given the fact that in currency market, market volatility risk; which is characterized by fluctuation of currency values which are often observed in various levels such as from standard deviation to measure of dispersion that is uncommonly higher than the standard deviation over a sustained period of time, is the cause of unexpected variance of asset return. It is helpful for currency holders to be provided a kind of currency that comprises hedging effect against market volatility risk in order to enable financial strategies such as to minimize unexpected variance of asset return.

Given the popularity and increase of global transactions of currencies that involve currency conversion and/or exchange, market volatility risk of exchange rate is part of the major cause of transaction cost and unexpected variance of asset return. It is helpful for currency holders to be provided a kind of currency that comprises hedging effect against market volatility risk in order to enable financial strategies such as to minimize unexpected variance of asset return.

Given the popularity and increase of cross border online shopping that involve currency conversion at the time of payment, market volatility risk of exchange rate is part of the major cause of additional cost and unexpected variance of asset return. It is helpful for currency holders to be provided a kind of currency that comprises hedging effect against market volatility risk in order to enable financial strategies such as to minimize unexpected variance of asset return.

Given the popularity and increase of multi-currency transaction including but not limited to cryptocurrency, digital currency, stable coin and other online currency that involve currency conversion and/or exchange, market volatility risk of exchange rate is part of the major cause of transaction cost and unexpected variance of asset return. It is helpful for currency holders to be provided a kind of currency that comprises hedging effect against market volatility risk in order to enable financial strategies such as to minimize unexpected variance of asset return.

In order to obtain hedging effect against market volatility risk, in general, asset holder may diversify their holdings. For more active approach, asset holder may invest dynamically in derivatives such as future of an asset, option of an asset and etc. Generally, diversifying asset holdings is the most common and recommended approach to risk management against market volatility risks.

Unfortunately, in conventional systems, although currencies and other assets are utilized by vast majority of people, tools, if not access to the tools to protect against market volatility risk are limited to financial professionals and other large financial institutes. Vast majority of people who utilize currencies are left without given any or not enough protections against the market volatility risk.

### SUMMARY OF THE DISCLOSURE

Embodiments of the invention provide a method and structure for allowing a creation of hybrid currency. For certain embodiments, a hybrid currency allows an individual to own a set of two different currencies by simply holding currencies in the individual hybrid currency.

Embodiments of the invention provide a method and structure for allowing a creation of volatility risk hedged currency. For certain embodiments, a volatility risk hedged currency allows an individual to own a set of more than two different currencies by simply holding currencies in the individual volatility risk hedged currency.

For some embodiments, a hybrid currency may provide a unit of value that is an average, including but not limited to equal-weighted average of component currencies of hybrid currency.

For some embodiments, a volatility risk hedged currency may provide a unit of value that is an average, including but not limited to equal-weighted average of component currencies of volatility risk hedged currency.

Certain embodiments of the invention provide a hedging effect against a volatility risk over a sustained period of time of an exchange rate and/or a cross rate between two currencies (i.e. a pair of currencies).

Certain embodiments of the invention provide a diversification and an opportunity to take lower correlated or non-correlated position at the time when a currency is experiencing a high volatility, sharp movement or collapse of an exchange rate against all other currencies (e.g. during currency crisis, collapse preceded by fundamental change in value that backs the currency and etc.).

Certain embodiments of the invention allow a sender and a receiver of cross border transaction to fairly share currency volatility risk between them.

Certain embodiments of the invention allow a sender and a receiver of cross border transaction to avoid currencies that are in high volatility risk.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example financial system, in accordance with certain embodiments of the present disclosure.

FIG. 2 illustrates an example operations of hybrid currency and volatility risk hedged currency's process flow, in accordance with certain embodiments of the present disclosure.

FIG. 3 illustrates an example structures of hybrid currency, in accordance with certain embodiments of the present disclosure.

FIG. 4 illustrates an example structures of volatility risk hedged currency, in accordance with certain embodiments of the present disclosure.

### DETAILED DESCRIPTION

Embodiments of the present disclosure provide a creation of hybrid currency which its value is tied to the value that represents a set of two currencies including but not limited to fiat currencies, cryptocurrencies and other online currencies.

Embodiments of the present disclosure provide a creation of volatility risk hedged currency which its value is tied to the value that represents a set of more than two currencies including but not limited to fiat currency, cryptocurrencies and other online currencies.

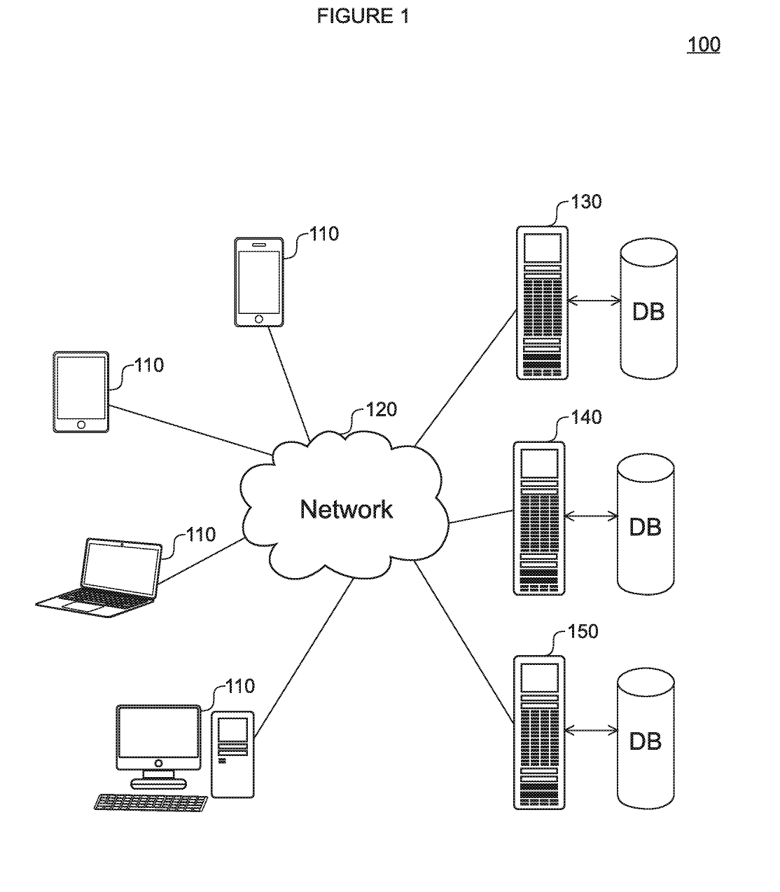

FIG. 1 illustrates an example financial system 100 in which embodiments of the present disclosure may be employed. The financial system for hybrid currency and/or volatility risk hedged currency may include but not limited to centralized system and/or peer-to-peer, decentralized system.

Embodiments of the present disclosure may allow an offering project 130 to serve as an issuer of hybrid currencies utilizing network 120 including but not limited to centralized network, peer-to-peer decentralized network and other kind of networks, that consists of a plurality of user computers 110 including smart phones, tablet computers, laptop computers and desktop computers.

Embodiments of the present disclosure may allow an offering project 130 to serve as an issuer of volatility risk hedged currencies utilizing network 120 including but not limited to centralized network, peer-to-peer decentralized network, and other kind of networks, that consists of a plurality of user computers 110 including smart phones, tablet computers, laptop computers and desktop computers.

Embodiments of the present disclosure may allow an exchange platform 140 to serve as an exchange center of hybrid currencies utilizing network 120 including but not limited to centralized network or peer-to-peer decentralized network, that consists of a plurality of user computers 110 including smart phones, tablet computers, laptop computers and desktop computers.

Embodiments of the present disclosure may allow an exchange platform 140 to serve as an exchange center of volatility risk hedged currencies utilizing network 120 including but not limited to centralized network or peer-to-peer decentralized network, that consists of a plurality of user computers 110 including but not limited to smart phones, tablet computers, laptop computers and desktop computers.

Embodiments of the present disclosure may allow a Financial account 150 including but not limited to digital wallet, electronic device, in-store account and other financial account providers, to serve by allowing user 110 to own and/or make electronic transactions of hybrid currencies utilizing network 120 including but not limited to centralized network or peer-to-peer decentralized network, that consists of a plurality of user computers 110 including but not limited to smart phones, tablet computers, laptop computers and desktop computers.

Embodiments of the present disclosure may allow a Financial account 150 including but not limited to digital wallet, electronic device, in-store account and other financial account providers, to serve by allowing user 110 to own and/or make electronic transactions of volatility risk hedged currencies utilizing network 120 including but not limited to centralized network or peer-to-peer decentralized network, that consists of a plurality of user computers 110 including but not limited to smart phones, tablet computers, laptop computers and desktop computers.

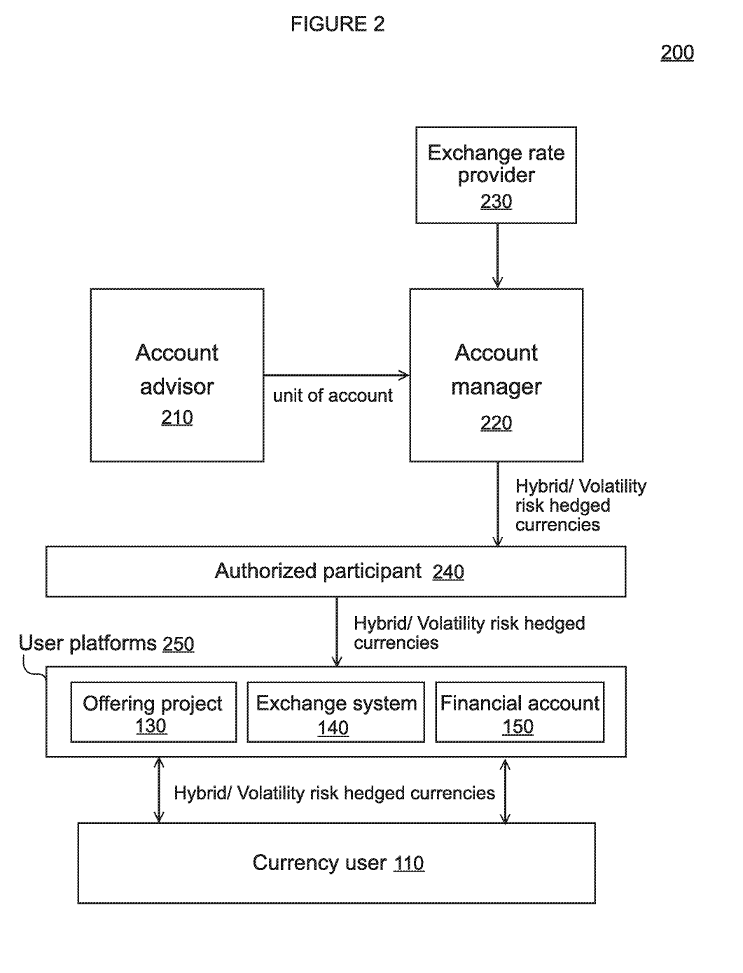

FIG. 2 illustrates an example operations of hybrid currency and/or volatility risk hedged currency's process flow 200 in which embodiments of the present disclosure may be employed. The parties described below and their roles exist for certain embodiments of a hybrid currency and/or a volatility risk hedged currency, and other embodiments may include additional and/or fewer parties, with the same, different, or overlapping roles. For an utility cryptocurrency or a fixed exchange rate currency (i.e. pegged currency), for example, an Authorized participant 240 may not be needed, since the currency does not require third party attestation to back its value.

Embodiments of the present disclosure may allow an Account advisor 210 to determine and specify the two component currencies required to create a hybrid currency. Certain embodiments may allow an Account advisor 210 to determine and specify the two component fiat currencies required to create a hybrid of a pair of fiat currencies (e.g. pair of U.S. dollar and Euro, pair of U.S. dollar and Japanese yen and other combinations of pair of fiat currencies.).

Embodiments of the present disclosure may allow an Account advisor 210 to determine and specify the component currencies of more than two that is required to create a volatility risk hedged currency. Certain embodiments may allow an Account advisor 210 to determine and specify the component fiat currencies of more than two that is required to create a volatility risk hedged fiat currencies (e.g. multiple of more than two currencies including but not limited to; U.S. dollar, Euro, Japanese yen, U.K. Pound and etc.).

Embodiments of the present disclosure may allow an Account advisor 210 to determine a composition weights for each component currencies. Component weights for each component currencies can be calculated using different approaches and various algorithms including but not limited to equal-weighted average.

Embodiments of the present disclosure may allow an Account advisor 210 to determine a composition weights for each component currencies. Component weights for each component currencies can be calculated using different approaches and various algorithms including but not limited to equal-weighted average.

Embodiments of the present disclosure may allow a unit of account of a hybrid currency to be transmitted from Account advisor 210 to Account manager 220.

Embodiments of the present disclosure may allow a unit of account of a volatility risk hedged currency to be transmitted from Account advisor 210 to Account manager 220.

Certain embodiments of the present disclosure may allow an Account manager 220 to obtain rate data related to the components of a hybrid currency from Exchange rate provider.

Certain embodiments of the present disclosure may allow an Account manager 220 to obtain rate data related to the components of a volatility risk hedged currency from Exchange rate provider.

Embodiments of the present disclosure may allow an Account manager 220 to generate a creation file of a hybrid currency, then, transmit it to Authorized participant 240.

Embodiments of the present disclosure may allow an Account manager 220 to generate a creation file of a volatility risk hedged currency, then, transmit it to Authorized participant 240.

Embodiments of the present disclosure may allow an Authorized participant 240 to participate in an example operation 200 in order to work functionally to support an operation of hybrid currency and/or volatility risk hedged currency. Certain embodiments may allow an Authorized participant 240 to support operation 200 in various ways including but not limited to, support place creation/or redemption order, process order, record supply of hybrid currency and/or volatility risk hedged currency, support a fair and orderly market, facilitate movement of hybrid currency and/or volatility risk hedged currency, etc. . . . . Certain embodiments may allow an Authorized participant 240 to apply consensus algorithm to work functionally to support operation 200. For some embodiments, an operation 200 may not need an Authorized participant 240.

Embodiments of the present disclosure may allow User platforms 250 to facilitate system and application to support Currency user 110 to access and utilize hybrid currencies and/or volatility risk hedged currencies.

User platforms 250 may include an Offering project 130, which serve as an issuer of hybrid currencies and/or volatility risk hedged currencies allowing Currency user 110 to purchase and/or obtain units of hybrid currency and/or volatility risk hedged currency.

User platforms 250 may include an Exchange system 140, which serve as an exchange allowing Currency user 110 to buy and sell units of hybrid currency and/or volatility risk hedged currency.

User platforms 250 may include an Financial accounts 150 including but not limited to digital wallet, electronic device, in-store account and other financial account providers, to serve by allowing Currency user 110 to own and make electronic transactions with hybrid currency and/or volatility risk hedged currency.

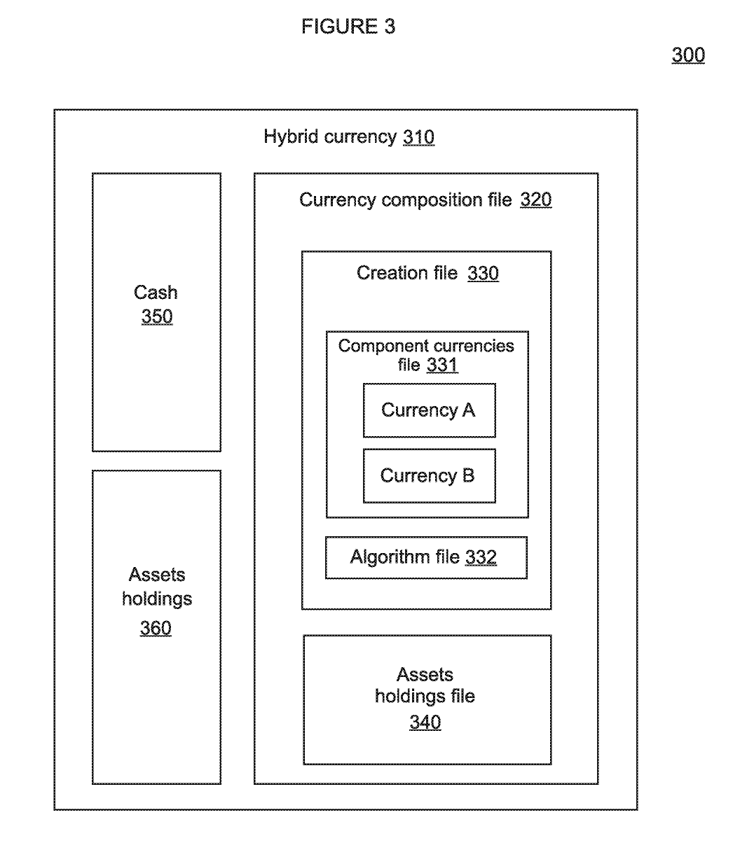

FIG. 3 illustrates an example structure of hybrid currency 300 in which embodiments of the present disclosure may be employed. Embodiments of the present disclosure allow a Hybrid currency 310 consists of Creation file 330 that include Component currencies file 331 and an Algorithm file 332.

Embodiments of the present disclosure allow Component currencies file 331 that consist of two different currencies.

Embodiments of the present disclosure allow an Algorithm file 332 that consists of various algorithms and different approaches of calculating component weight of each component currencies including but not limited to equal-weighted average.

For some embodiments, a Currency composition file 320 may also include Assets holdings file 340 consists of a representation of Assets holdings 360 in order to support valuation, transparency and for other reporting purposes.

For some embodiments, a Hybrid currency 310 may also hold Cash 350. In some instances, when a Component currencies file 331 include less liquid and less accessible currencies, Cash 350 may hold equivalent amount of currencies with greater amount of liquidity and accessibility including but not limited to US dollar and etc.

For some embodiments, a Hybrid currency 310 may also include some Assets holdings 360. Assets included in Assets holdings 360 may be selected based on factors and/or characteristics related to the Assets holdings file 340. For example, Treasury bills (T-bills), Treasury notes (T-notes), Certificates of deposit (CD), municipal bond may be held to support a Hybrid currency 310 that holds US dollar in their Component currencies file 331.

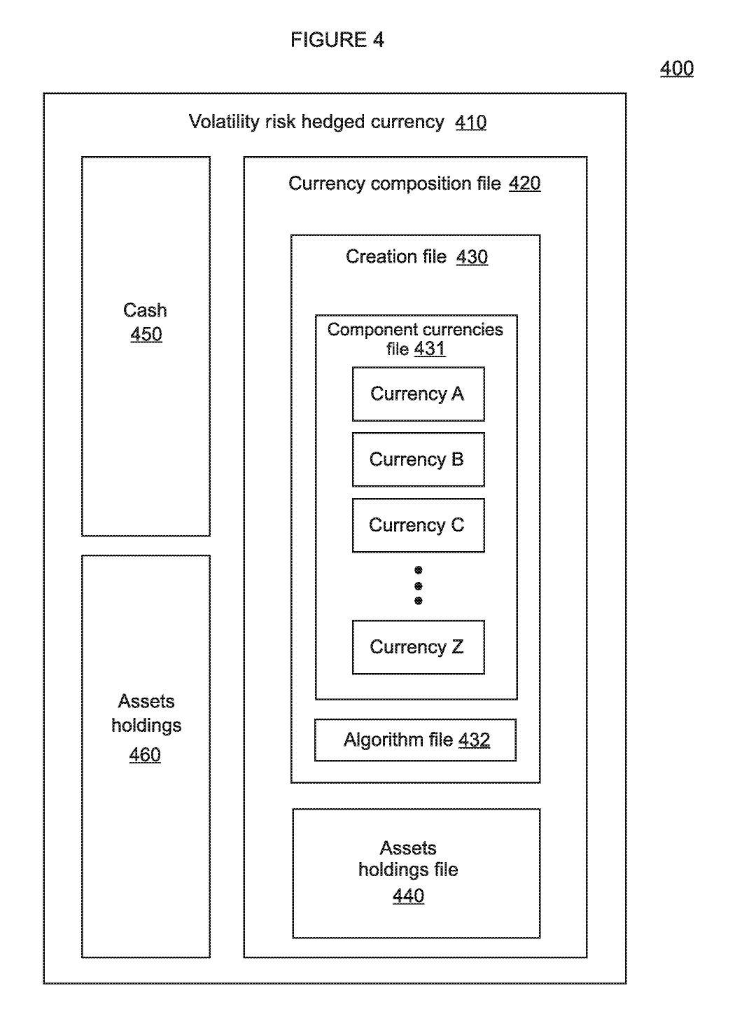

FIG. 4 illustrates an example structure of volatility risk hedged currency 400 in which embodiments of the present disclosure may be employed. Embodiments of the present disclosure allow a Volatility risk hedged currency 410 consists of Creation file 430, that include Component currencies 431 and an Algorithm file 432.

Embodiments of the present disclosure allow Component currencies 431 that consist of more than two different currencies.

Embodiments of the present disclosure allow an Algorithm file 432 that consists of various algorithms and different approaches of calculating component weight of each component currencies including but not limited to equal-weighted average.

For some embodiments, a Currency composition file 420 may also include Assets holdings file 440 consists of a representation of Assets holdings 460 in order to support valuation, transparency and for other reporting purposes.

For some embodiments, a Volatility risk hedged currency 410 may also hold Cash 450. In some instances, when a Component currencies file 431 include less liquid and less accessible currencies, Cash 450 may hold equivalent amount of currencies with greater amount of liquidity and accessibility including but not limited to US dollar and etc.

For some embodiments, a Hybrid currency 410 may also include some Assets holdings 460. Assets included in Assets holdings 460 may be selected based on factors and/or characteristics related to the Assets holdings file 440. For example, Treasury bills (T-bills), Treasury notes (T-notes), Certificates of deposit (CD), municipal bond may be held to support a Hybrid currency 310 that holds US dollar in their Component currencies 431.

It is to be understood that the claims are not limited to the precise configuration and components illustrated above. Various modifications, changes and variations may be made in the arrangement, operation and details of the methods, structures and components described above without departing from the scope of the claims.

1. A method and structure for hybrid currency, comprising:
specifying a set of component currencies which is a set of two different currencies to initiate a creation of hybrid currency; and
obtaining an unit of account by applying algorithm and/or calculation to the set of component currencies specified.

2. The method of claim 1, where in the set of component currencies specifies fiat currencies.

3. The method of claim 1, where in the set of component currencies specifies cryptocurrencies.

4. The method of claim 1, where in the algorithm and/or calculation to obtain the unit of account includes the method of equal-weighted average of two component currency values.

5. The method of claim 1, where in the algorithm and/or calculation to obtain the unit of account includes the method of a weighted average of component currency values, where each component currency values are weighted with different levels of relevance.

6. The method of claim 1, where in the algorithm and/or calculation to obtain the unit of account include the method of summing each of two component currencies by the values in U.S. dollars.

7. The method of claim 1, where in the algorithm and/or calculation to obtain the unit of account include the method of summing each of two component currencies by the values in a specific fiat currency.

8. A method and structure for volatility risk hedged currency, comprising:
specifying a set of component currencies which is a set of more than two different currencies to initiate a creation of volatility risk hedged currency; and
obtaining an unit of account by applying algorithm and/or calculation to the set of component currencies specified.

9. The method of claim 8, where in the set of component currencies specifies fiat currencies.

10. The method of claim 8, where in the set of component currencies specifies cryptocurrencies.

11. The method of claim 8, where in the algorithm and/or calculation to obtain the unit of account include the method of equal-weighted average of component currency values.

12. The method of claim 8, where in the algorithm and/or calculation to obtain the unit of account include the method of a weighted average of component currency values, where each component currency values are weighted with different levels of relevance.

13. The method of claim 8, where in the algorithm and/or calculation to obtain the unit of account include the method of summing each of component currencies by the values in U.S. dollars.

14. The method of claim 8, where in the algorithm and/or calculation to obtain the unit of account include the method of summing each of two component currencies by the values in a specific fiat currency.

15. A method and structure for hybrid currency and/or volatility risk hedged currency, comprising:
holding Cash and including Asset holdings.

16. The method of claim 15, where in selecting Cash and Asset holdings based on factors and/or characteristics related to the component currencies of hybrid currency and/or volatility risk hedged currency.

17. The method of claim 15, where in including Cash amount substituted by equivalent amount of U.S. dollar and Asset holdings substituted by equivalent amount of U.S. dollar based Asset holdings.

18. The method of claim 15, where in including Cash amount substituted by equivalent amount of specific fiat currency and Asset holdings substituted by equivalent amount of specific fiat currency based Asset holdings.
